(19) United States
(12) Patent Application Publication
(10) Pub. No.: US 2005/0231800 A1
(43) Pub. Date: Oct. 20, 2005

(54) Selective reflecting

(76) Inventor: Barret Lippey, Belmont, MA (US)

Correspondence Address: FISH & RICHARDSON PC, P.O. BOX 1022, MINNEAPOLIS, MN, 55440-1022, US

(21) Appl. No.: 11/033,214

(22) Filed: Jan. 10, 2005

Related U.S. Application Data
(63) Continuation-in-part of application No. 10/789,695, filed on Feb. 27, 2004.
Application No. 10/789,695 is a continuation-in-part of application No. 10/028,063, filed on Dec. 21, 2001, now Pat. No. 6,847,483.
(63) Continuation-in-part of application No. 10/931,608, filed on Sep. 1, 2004.
(63) Continuation-in-part of application No. 10/893,461, filed on Jul. 16, 2004.

(51) Int. Cl. G03B 21/20; G03B 21/56

(52) U.S. Cl. 359/443; 353/85

(57) ABSTRACT

A projection system that includes a projector that projects light in wavelength bands, including a non-laser light source and a screen that includes at least two metal layers separated by a layer of dielectric material. The screen is constructed and arranged to reflect light in the wavelength bands projected by the projector and to not reflect light not in the wavelength bands.

### REFERENCE TO RELATED APPLICATIONS

This application is a continuation-in-part of U.S. of U.S. patent application Ser. No. 10/789,695 filed Feb. 27, 2004, which is a continuation in part of U.S. patent application Ser. No. 10/028,063 filed Dec. 21, 2001; a continuation in part of U.S. patent application Ser. No. 10/931,608 filed Sep. 1, 2004; and a continuation in part of U.S. patent application Ser. No. 10/893,461 filed Jul. 16, 2004, all of which are incorporated by reference in their entirety.

### BACKGROUND

This specification describes projection screens that selectively reflect incident light in selected frequency bands, more specifically selectively reflecting projection screens that include at least two layers of a reflective material, such as a metal, with dielectric material between the layers of reflective material. One example of such selectively reflecting projection screens, specifically a single dielectric layer between two metallic layers, is described in U.S. Published patent application 2003/0156326 (hereinafter '326).

According to '326, at paragraph [0010], “Projection screens must have special optical properties in order to ensure brilliant image representation. This applies especially to laser projection, in which a deflectable laser beam, into which the primary colors red, green and blue are coupled, scans the screen. The projection screens must have reflection maxima in the red, green, blue wavelengths of approximately 629 nm, 532 nm, and 457 nm, respectively.” (emphasis added). Application '326 purports to have reflection maxima at 445 nm, 525 nm, and 629 nm.

Another example of a selectively reflecting projection screen including layers of a reflective material and a layer of dielectric material is described in Japanese Published Application JP2004-101558A (hereinafter '558). The multilayer film described in '558 includes alternating layers of metallic material and dielectric material. Application '558 purports to have a 70% reflectance to light of red light of wavelength 642 nm, green light of wavelength 532 nm, and blue light of 457 nm.

### SUMMARY

In general, in one aspect of the invention a projection system includes a projector for projecting light in wavelength bands. The projector includes a non-laser light source. The projection system also includes a screen comprising at least two metallic layers separated by a layer of dielectric material constructed and arranged to reflect light in the wavelength bands and to not reflect light not in the wavelength bands.

The light source may be a bulb. The bulb may have a non-flat emission spectrum. The bulb may be a short-arc mercury vapor bulb. The non-flat emission spectrum may have an energy peak at a predetermined wavelength and the projector may include a filter to filter light in a wavelength band including the predetermined wavelength to decrease the relative amount of energy in the wavelength band relative to the amount of energy in other wavelength bands. The non-flat emission spectrum may have a second energy peak at a second predetermined wavelength, and the projector may include a second filter to filter light in a second wavelength band including the second predetermined wavelength to decrease the relative amount of energy in the second wavelength band relative to the amount of energy in other wavelength bands. The projector may include a light source for supplementing in a band of wavelengths the light energy emitted by the bulb.

The light source may have a broadband emission spectrum having an emission peak at an emission peak wavelength. One of the bands may include the emission peak wavelength. The light source may include a mercury vapor bulb and the emission peak may occur at approximately 550 nm. A second of the wavelength bands may include 470 nm.

The projector may project light in wavelength bands that are greater than 50 nm wide at full-width half-maximum.

In another aspect of the invention, a projection system includes a screen, constructed and arranged to reflect light in pre-determined wavelength bands and to not reflect light not in the pre-determined wavelength bands. The projection system also includes a projector, constructed and arranged to emit light in the pre-determined wavelength bands. The projector includes a non-laser light source having a non-flat emission spectrum having an emission peak in a first of the wavelength bands. The projection system further includes an emission spectrum modifier to modify the non-flat emission spectrum by increasing the energy in a second of the pre-determined wavelength bands relative to the energy in the first wavelength band.

The emission spectrum modifier may include a filter to reduce emission in the spectral portion including the emission peak.

The emission spectrum modifier may further include a narrowband supplementary light source to increase the energy in a spectral portion not having an emission peak. The spectral portion may correspond to one of the pre-determined wavelength bands

In another aspect of the invention, a projection system includes a projector for projecting light in wavelength bands. The projector includes a light source with a non-flat broadband emission spectrum having an emission peak at an emission peak wavelength. The projection system further includes a screen comprising at least two metallic layers separated by a layer of dielectric material constructed and arranged to reflect light in the wavelength bands and to not reflect light not in the wavelength bands. A first of the wavelength bands includes the emission peak wavelength.

The light source may be a mercury vapor bulb and the emission peak wavelength may be approximately 550 nm. A second of the wavelength bands may include 470 nm.

The projector may be constructed and arranged to project light in wavelength bands that have a width of greater than 50 nm at full-width half-maximum.

The screen may further include at least one additional metallic layer separated from the second metallic layer by a second dielectric layer. The thickness of the additional reflective layer may be the same as the second reflective layer. The thickness of the second dielectric layer may be the same as the thickness of the first dielectric layer.

The screen may further include a plurality of alternating layers of dielectric material and metallic layers, disposed on the second metallic layer. The alternating layers of dielectric material may have the same thickness as the first layer of dielectric material and the alternating metallic layers may have the same thickness as the second metallic layer.

The alternating layers of dielectric material may have different thicknesses.

In still another aspect of the invention, a projection screen constructed and arranged so that the reflectivity of light in a plurality of predetermined wavelength bands is significantly greater than the reflectivity of light in other wavelength bands, includes a first and second layer of reflective material, separated by a layer of a dielectric material. The central wavelengths of the wavelength bands of greater reflectivity are given by

$$λ = \frac{2 nD + nM + 2 nC}{m}$$

where values of λ are the central wavelengths of the wavelength bands, n is the index of refraction of the dielectric material; D is the thickness of the layer of dielectric material in nanometers; M is the thickness of the second reflective layer in nanometers, C is a constant depending on the material of the first reflective layer and m is an integer that represents the number of the peak.

The projection screen may further include a third layer of reflective material, separated from the second layer of reflective material by a second layer of the dielectric material, wherein the central wavelengths of the wavelength bands of greater reflectivity are given by

$$λ = \frac{2 nD + nM + 2 nC}{m}$$

where values of λ are the central wavelengths of the wavelength bands, n is the index of refraction of the dielectric material of the first and second layers of dielectric material; D is the thickness of the first and second layers of dielectric material in nanometers; M is the thickness of the second and the third reflective layer in nanometers, C is a constant depending on the material of the first reflective layer and m is an integer that represents the number of the peak.

The projection system may also include an alternating plurality of layers of dielectric material and reflective material, wherein the central wavelengths of the wavelength bands of greater reflectivity are given by

$$λ = \frac{2 nD + nM + 2 nC}{m}$$

where values of λ are the central wavelengths of the wavelength bands, n is the index of refraction of the dielectric material of the alternating plurality of layers of dielectric material; D is the thickness of the alternating layers of dielectric material in nanometers; M is the thickness of the alternating reflective layers in nanometers, C is a constant depending on the material of the first reflective layer and m is an integer that represents the number of the peak. The values of m may be 7, 8, and 9.

Other features, objects, and advantages will become apparent from the following detailed description, when read in connection with the following drawing, in which:

### BRIEF DESCRIPTION OF THE SEVERAL VIEWS OF THE DRAWING

FIG. 1 is a color chart with figures representing the color reproduction capabilities of two selective reflecting screens;

FIG. 2 is a photopic response curve;

FIG. 3A is a graph of an emission spectrum of a typical short-arc mercury vapor bulb;

FIG. 3B is a graph of the emission spectrum of FIG. 3A superimposed on the photopic curve of FIG. 2;

FIG. 4 is a color chart;

FIG. 5 is a graph of the normalized output of a mercury vapor bulb employing filtering and wavelength band enhancement techniques superimposed on the emission spectrum of FIG. 3A;

FIG. 6 is a diagrammatic cross-sectional view of a single stack, multilayer, multiband interference filter using an etalon structure;

FIG. 7 is a table of materials and thicknesses usable in the structure of FIG. 6;

FIG. 8A is curve representing the spectral response of the interference filter of FIGS. 6 and 7, superimposed on the normalized output of the mercury vapor bulb employing filtering and wavelength band enhancement techniques;

FIG. 8B is a graph of the spectral response of the interference filter of FIGS. 6 and 7, superimposed on the photopic curve;

FIG. 9 is a color chart showing the color reproduction capabilities of a screen employing the interference filter of FIGS. 6 and 7;

FIG. 10A is a graph of the normalized output of a mercury vapor bulb employing the filtering and wavelength band enhancement techniques of FIG. 5 superimposed on the spectral response of a selective reflecting screen;

FIG. 10B is the photopic curve superimposed on the spectral response of the selective reflecting screen of FIG. 10A;

FIG. 11A is a graph of the normalized output of a mercury vapor bulb employing the filtering and wavelength band enhancement techniques of FIG. 5 superimposed on the spectral response of another selective reflecting screen;

FIG. 11B is the photopic curve superimposed on the spectral response of the selective reflecting screen of FIG. 11A;

FIG. 12A is a graph of the normalized output of a mercury vapor bulb employing the filtering and wavelength band enhancement techniques of FIG. 5 superimposed on the spectral response of the screen of FIG. 10A with modified layer thickness as described in the specification;

FIG. 12B is the photopic curve superimposed on the spectral response of the selective reflecting screen of FIG. 12A;

FIG. 13A is a graph of the normalized output of a mercury vapor bulb employing the filtering and wavelength band enhancement techniques of FIG. 5 superimposed on the spectral response of the screen of FIG. 10A with a second modified layer thickness as described in the specification;

FIG. 13B is the photopic curve superimposed on the spectral response of the selective reflecting screen of FIG. 13A

FIG. 14A is a graph of the normalized output of a mercury vapor bulb employing the filtering and wavelength band enhancement techniques of FIG. 5 superimposed on the spectral response of a multilayer screen with varying layers thicknesses; and

FIG. 14B is the photopic curve superimposed on the spectral response of the selective reflecting screen of FIG. 14A

### DETAILED DESCRIPTION

“Narrowband” as used herein refers to light sources having emission spectra having light energy emission peaks at some range of wavelengths having a full-width-half-maximum (FWHM) bandwidth of approximately 50 nm or less, typically less than a few nanometers for lasers and approximately 20 to 40 nm for LED sources, and having substantially no light energy emission at other wavelengths. “Broadband” as used herein refers to light sources having some light energy emission over a broad portion of the visible spectrum. “Flat” as used herein refers to a broadband emission spectrum that has substantially uniform light energy emission over a wide range of wavelengths of the visible spectrum. “Non-flat” as used herein refers to a broadband emission spectrum that has light energy emission peaks at some wavelengths and significantly reduced light energy emission at some other wavelength bands of the visible spectrum. The selective reflecting screens described herein include layers of reflective material. The most suitable substances to use for the layers of reflective material are metals, and some selective reflecting screens refer to metal or metallic layers. It is understood that other materials or combinations of materials (such as layers of dielectric materials) may be substituted for the metallic layers, so the terms “metal” and “metallic” as used herein include other substances that have reflective characteristics similar to metals.

Selective reflecting screens are most effectively used with projectors that project light in spectral bands that match the spectral bands of high reflectance of the screen. One type of light source for use in projectors for use with selectively reflecting screens is a laser light source. Both '558 and '326 use projectors that have lasers as the light source. Laser light sources are characterized by narrowband emission spectra with very narrow emission peaks, with a high degree of control over the wavelength of the emitted light. For selective reflecting screens designed to be used with projectors with laser light sources, the wavelength characteristics of the light source can be varied to fit a variety of circumstances, such as different combinations of wavelength bands selectively reflected by a screen. LED light sources have characteristics similar to laser light sources, but the emission peaks are not as narrow.

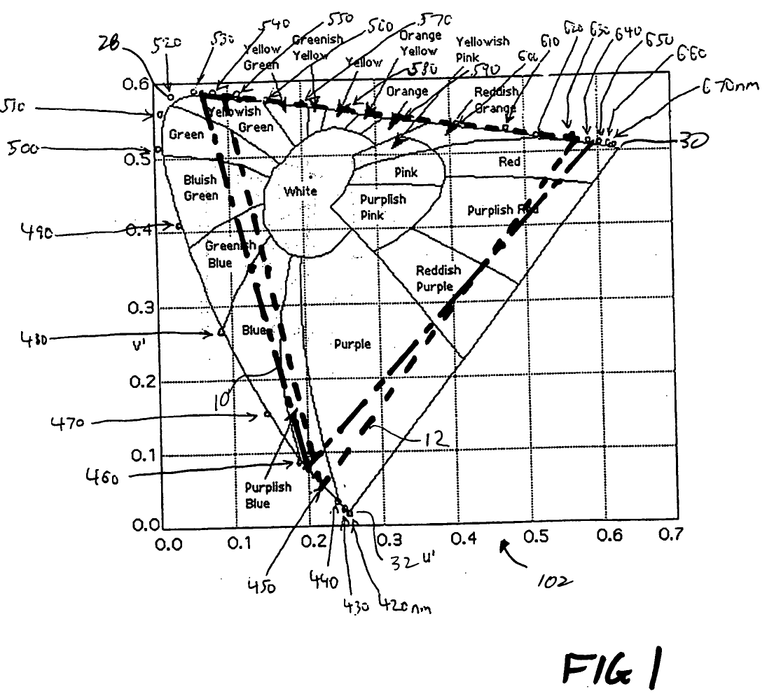

One consideration for choosing the wavelength bands to be selectively reflected is color gamut. For example, referring to FIG. 1, there is shown a color chart 102 illustrating the color reproduction capabilities of the screen described in the '558 application. The screen described in the '558 application can reproduce the portion of the color chart enclosed by a triangle 10 defined by the selectively reflected wavelengths. Generally, it is desirable to maximize the area enclosed by the triangle, however there is often a tradeoff with the photopic response curve, as described below. One of the methods for maximizing the area of the triangle is to choose selectively reflected wavelengths that are as close as possible to the corners 28, 30, 32 of the color chart 102. FIG. 1 also shows the color reproduction capabilities of the screen described in the '326 application, represented by triangle 12.

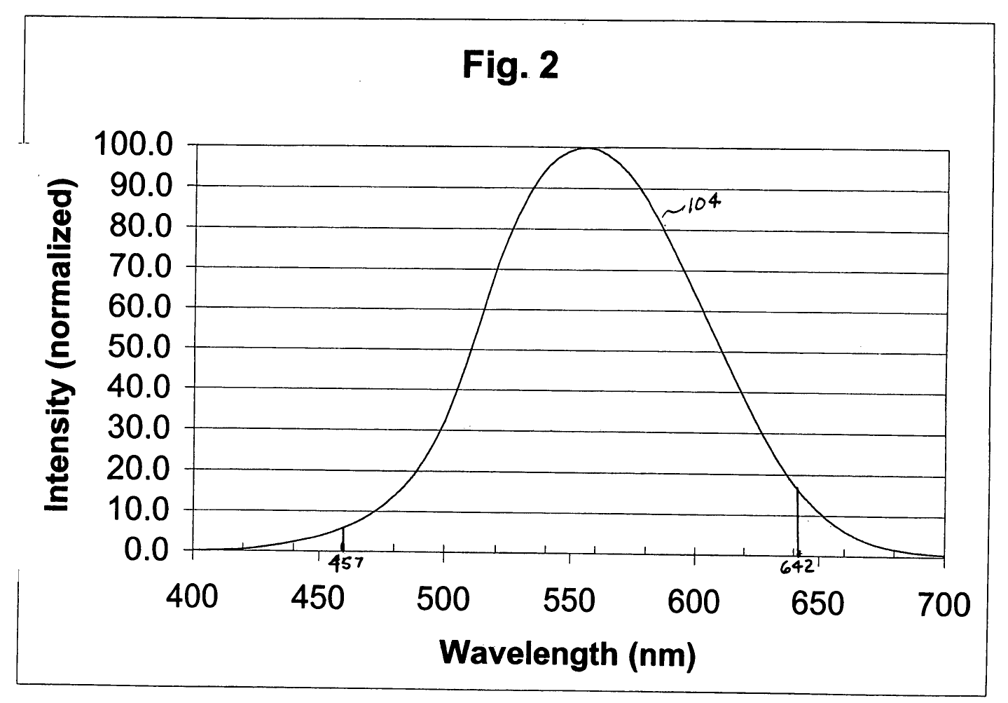

Another consideration for choosing the selectively reflected wavelengths is the photopic response curve 104 of the sensitivity of the human eye, shown in FIG. 2. The 642 nm selectively reflected (red) wavelength of the screen described in application '558 enables the screen to have a color gamut that includes a wide range of red colors, but the human eye is not particularly sensitive to the 642 nm wavelength, so much of the advantage of the relatively wide range of red colors is mitigated. Similarly, the 457 nm selectively reflected (blue) wavelength of the screen described in application '326 enables the screen to have a color gamut that includes a wide range of blue colors, but the human eye is not particularly sensitive to the 457 nm wavelength, so much of the advantage of the relatively wide range of blue colors is mitigated.

Projection systems with projectors using lasers as light sources have some disadvantages. For example, projectors using lasers as light sources are relatively expensive. There are safety concerns, especially in an uncontrolled environment, such as a home theater. Additionally, the narrowband nature of laser light sources can be a disadvantage due to color shift. Color shift occurs when images on a multilayer dielectric film narrow-band wavelength-selective projection screen are viewed at an angle, the reflection peaks of the screen typically shift towards shorter wavelengths and no longer match the wavelengths of the projector. This results in very limited viewing angles. Also, projection systems using laser light sources are prone to speckle, which is a pattern of light and dark spots on the screen caused by interference effects. Visible speckle occurs when the projector light is sufficiently coherent to produce interference in the screen.

Another type of light source for use in projectors that can be used with selectively reflecting screens is a bulb-type light source. One type of bulb projector light source is a xenon bulb. Xenon bulbs have a relatively flat broadband emission spectrum, so they may be used in combination with filters with passbands in the range desired for the selectively reflected wavelength bands. The passbands can be made wide enough that the color shift problem associated with narrowband screens (such as those used with lasers) can be mitigated. Filtered xenon bulb light sources are characterized by a high degree of control over the wavelengths of the emitted light (by selecting the passbands of the filters) and by much wider emission peaks than laser light sources. A projector using a xenon bulb can be made less expensively than a projector using lasers, and a xenon bulb projector does not have the same safety concerns as a laser projector. Similar to projection systems with laser-light-source projectors, considerations for choosing the selectively reflected wavelength bands include color gamut and the sensitivity of the human eye. The light radiated by bulb-type projectors is not sufficiently coherent to cause speckle problems with most screens, so projection systems using bulb-type projectors are not prone to speckle. One disadvantage of a projector using a filtered xenon bulb is that the flat emission spectrum of a xenon bulb results in a significant amount of energy being filtered out when filtering into conventional red, green, and blue bands.

Another type of projector for a selective-reflecting projection system uses a bulb that has a broadband non-flat emission spectrum, such as a short-arc (typically less than 5 mm arc length) mercury vapor bulb, sometimes referred to as an ultra-high pressure (UHP) bulb. Similar to projection systems with laser light source projectors and projection systems with filtered, flat-emission spectra bulbs, considerations for choosing the selectively reflected wavelength bands include color gamut and the sensitivity of the human eye. However for projection systems with non-flat emission spectra bulbs, there are additional considerations. The additional considerations include the wavelength bands of the peaks and dips of the emission spectrum.

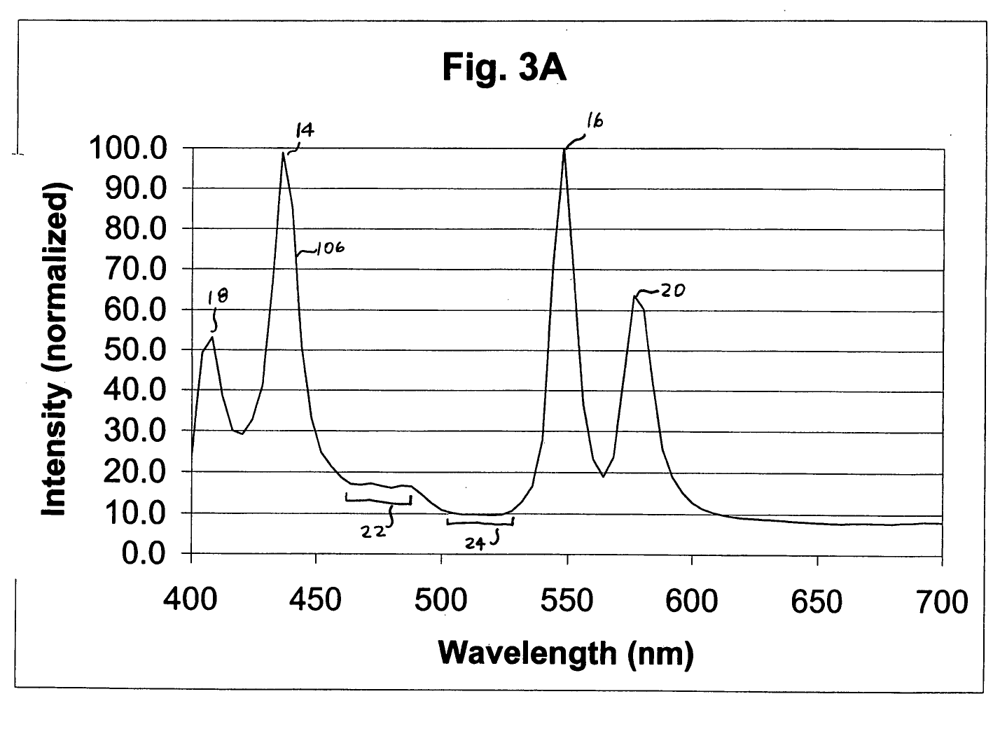

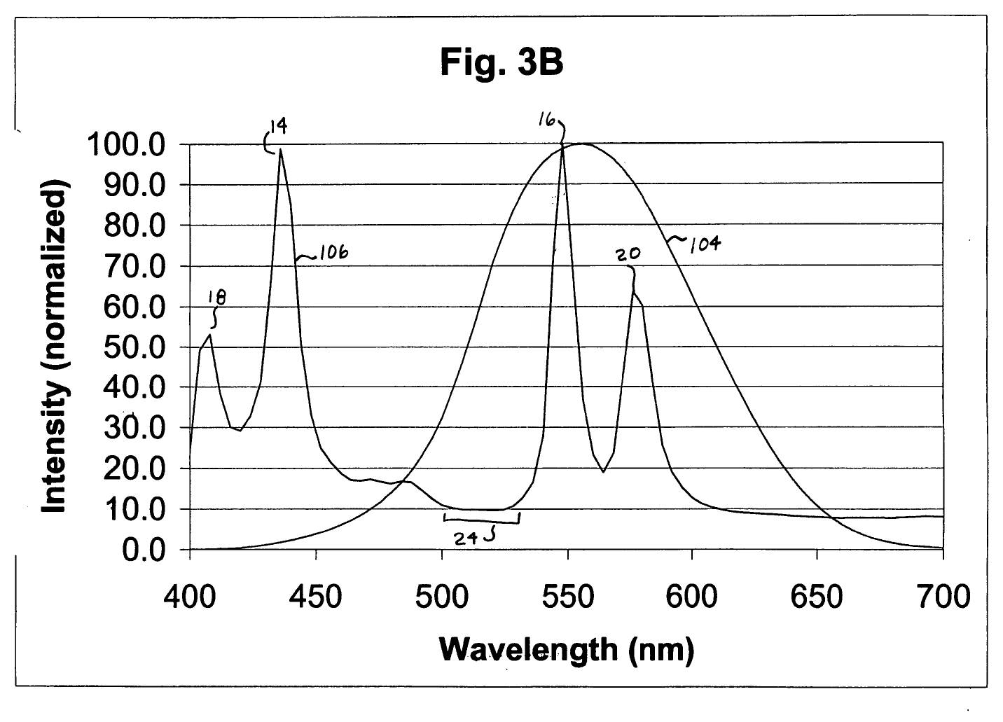

FIG. 3A shows an emission spectrum 106 of a typical short-arc mercury vapor bulb. Short-arc mercury vapor bulbs are among the more common types of non-flat emission-spectrum bulbs. The characteristics of the emission spectrum of a bulb are related to the vapor in the bulb. Bulbs having materials other than mercury vapor in the bulb, such as metal halide bulbs, have different emission spectrum characteristics. The specification below will describe the projection system using a mercury vapor bulb as the light source, it being recognized that the principles described herein can be applied to bulbs having other materials in the bulb. The spectrum 106 of FIG. 3 has a pronounced peak 14 at about 435 nm, a pronounced peak 16 at about 550 nm, a lesser peak 18 at about 410 nm, a lesser peak 20 at about 575 nm, an intermediate dip 22 between about 460 nm and about 490 nm and a deeper dip 24 between about 490 nm and about 530 nm.

FIG. 3B shows the emission spectrum 106 with the photopic curve 104 superimposed. The energy peak 14 at about 435 nm and the energy peak 18 at about 410 are at wavelengths at which the human eye is not very sensitive, so the energy peaks 14 and 18 may not be useful from a photopic curve standpoint. Additionally, energy peaks 14 and 18 are in or near the ultraviolet (UV) range. Ultraviolet light can be harmful to some projector components. However the energy peak 16 at about 550 nm and the energy peak 20 at about 575 nm are at wavelengths at which the human eye is sensitive, so that from a photopic curve standpoint, energy peaks 16 and 20 may be useful. The energy dip 24 between about 490 nm and about 530 nm is convenient because it would otherwise need to be filtered to decrease the light emission outside the spectrally selective wavelength bands.

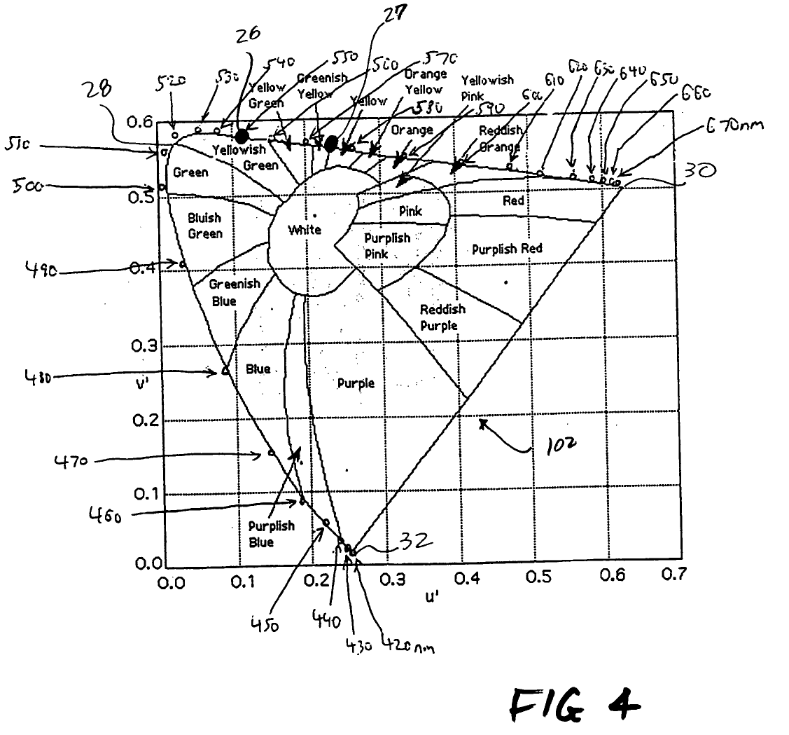

Referring now to FIG. 4, there is shown color chart 102. The 550 nm wavelength point 26 is near corner 28 of the color chart 102, so a band of frequencies including 550 nm is useful, from a color gamut standpoint, as a selectively reflected wavelength band. The energy peak 20 at about 575 nm, represented by point 27, is near the midpoint of one of the edges of color chart 102; therefore, a band of frequencies including 575 nm is not useful as a selectively reflected wavelength band from a color gamut standpoint and may even be disadvantageous because if it is combined with the peak at 550 nm to form the green selectively reflected band, the green selectively reflected band shifts away from corner 28.

Referring to FIGS. 4 and 3B, the range of wavelengths from 610 nm to 670 nm in corner 30 of the color chart are desirable from a color gamut standpoint but are at points of the photopic curve 104 indicating low sensitivity of the human eye. It may therefore be useful to increase the relative amount of energy in the 610 to 670 nm range to compensate for the low eye sensitivity.

One method for increasing the relative amount of energy in the 610 to 670 nm range and in the 420 to 470 nm range is to filter the emission from the mercury vapor bulb to attenuate emission peaks. For example, the energy peaks 14 and 18 of FIG. 3B are not useful from a photopic curve standpoint, so energy peaks 14 and 18 may be filtered. The energy peak 20 is not useful from a color gamut standpoint, so it may also be filtered. The energy peak 16 at about 550 nm is useful from both a color gamut standpoint and a photopic curve standpoint; however, as described in U.S. patent application Ser. No. 10/028,063, there may be more energy at 550 nm than is needed, so this energy peak may also be filtered. Reducing the amount of energy in the 550 nm band has the effect of increasing the relative amount of energy in other bands, such as the 610 to 670 nm band and the 420 to 470 nm band).

In addition to increasing the relative amount of energy in the 610 to 670 nm wavelength band and the 420 to 470 nm wavelength band, the absolute amount of energy in one or more of the energy bands may be increased. For example, U.S. patent application Ser. Nos. 10/893,461 and 10/028,063 describe methods and apparatuses for increasing the light in the red (610 to 670 nm) wavelength band.

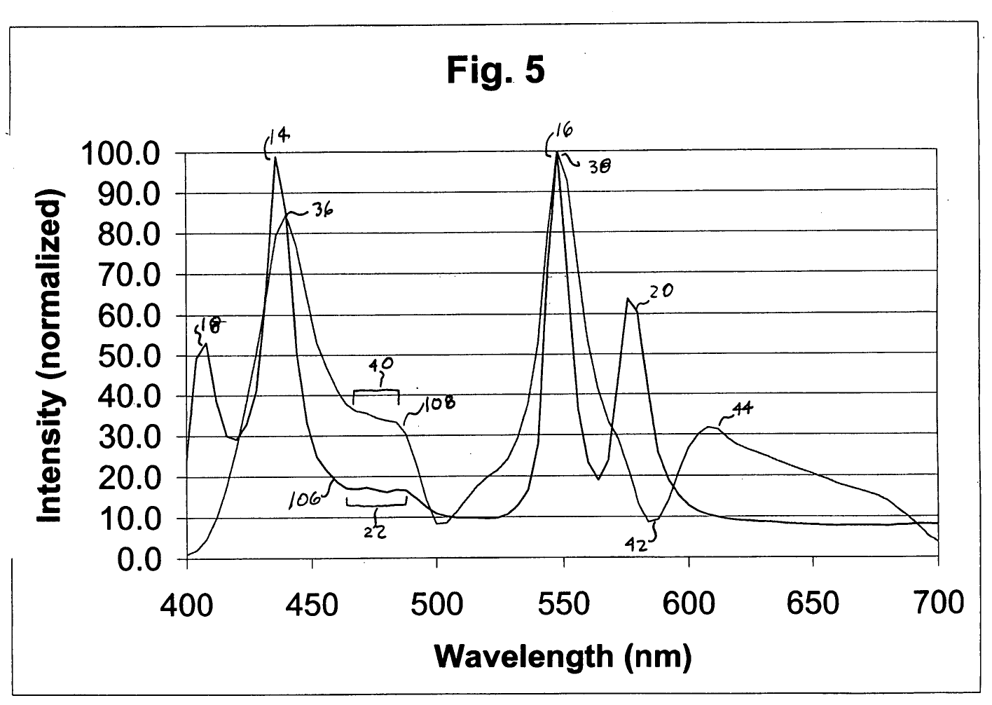

FIG. 5 shows a curve 106 representing the normalized emission spectrum of a typical mercury vapor bulb and a curve 108 representing the emission spectrum of a projector using the mercury vapor bulb represented by curve 106 and employing filtering and wavelength band enhancing techniques described above. Curve 106 has a peak 36 occurring at about the same wavelength as bulb peak 14, a peak 38 occurring at substantially the same wavelength as bulb peak 16, a “shelf” 40 at about the same wavelength band as intermediate dip 22, a dip 42 at a slightly higher wavelength than bulb peak 20, and a peak 44 of enhanced red radiation.

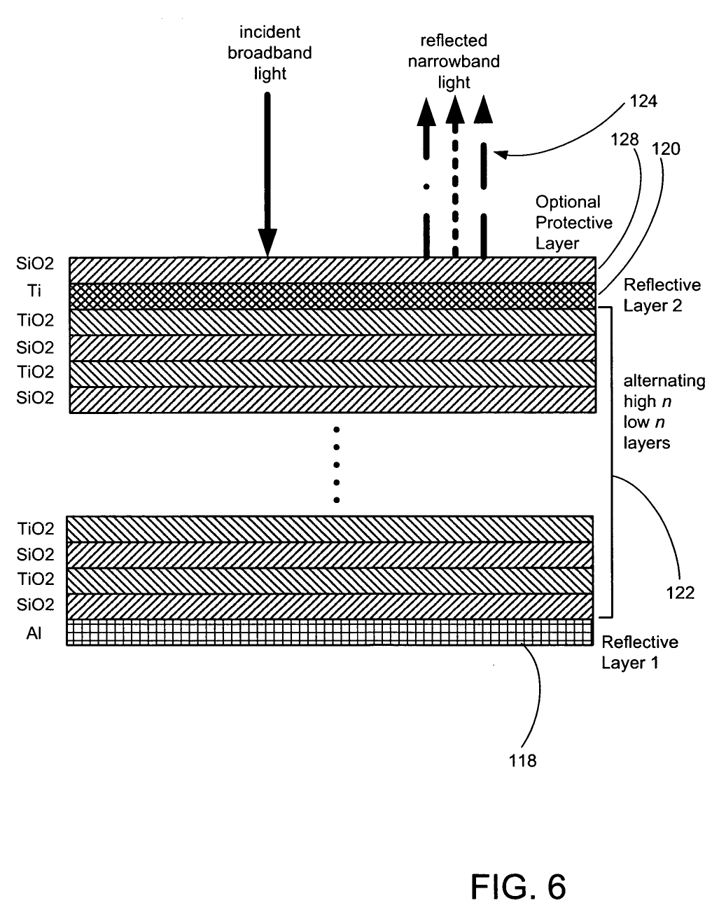

Referring to FIG. 6, there is shown a single stack, multilayer, multiband interference filter using an etalon structure. A first reflective layer 118, for example a highly reflective layer, for example of a material such as aluminum, and a second reflective layer 120, for example of a partially reflective layer of a material such as titanium, are separated by a plurality 122 of layers of dielectric materials, each layer of a material with a different index of refraction (n) than the material of the adjacent layer or layers of dielectric material. The reflectance of light in a plurality of wavelengths is significantly greater, as indicated by arrows 124, than light of other wavelengths; light of other wavelengths destructively interferes in the etalon device. The reflective layers may also be multilayer interference devices with layer thicknesses and materials selected so that the multilayer interference devices are highly reflective broadband; for convenience and simplicity, the reflecting layers will be shown as single layers in the figures. If desired, there may also be an optional protective layer 128 of a suitable material such as SiO₂.

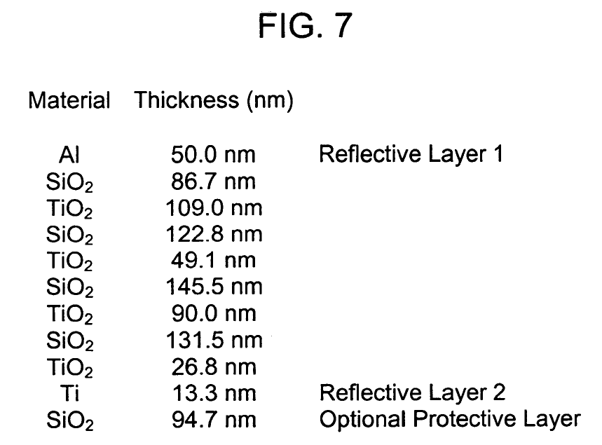

Referring to FIG. 7, there is shown a table of materials and thicknesses that, when used in the structure of FIG. 6 selectively reflects light in a plurality of pre-determined wavelength bands such as the red, green, and blue wavelength bands. The layers are listed in order of deposition. So, for example, the Al layer 50.0 nm thick is the first layer deposited and corresponds to first reflective layer 118 and the SiO₂ layer 94.7 nm thick is the last layer deposited and is therefore the optional top protective layer 128. The layers described in FIG. 7 are typically deposited on a substrate that provides mechanical support.

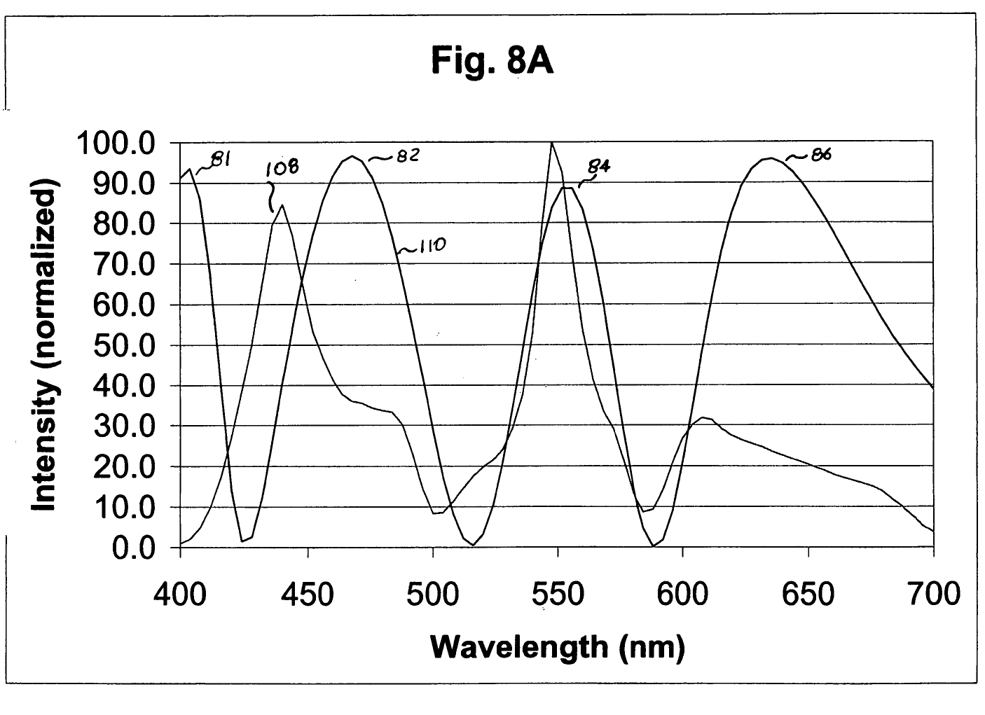

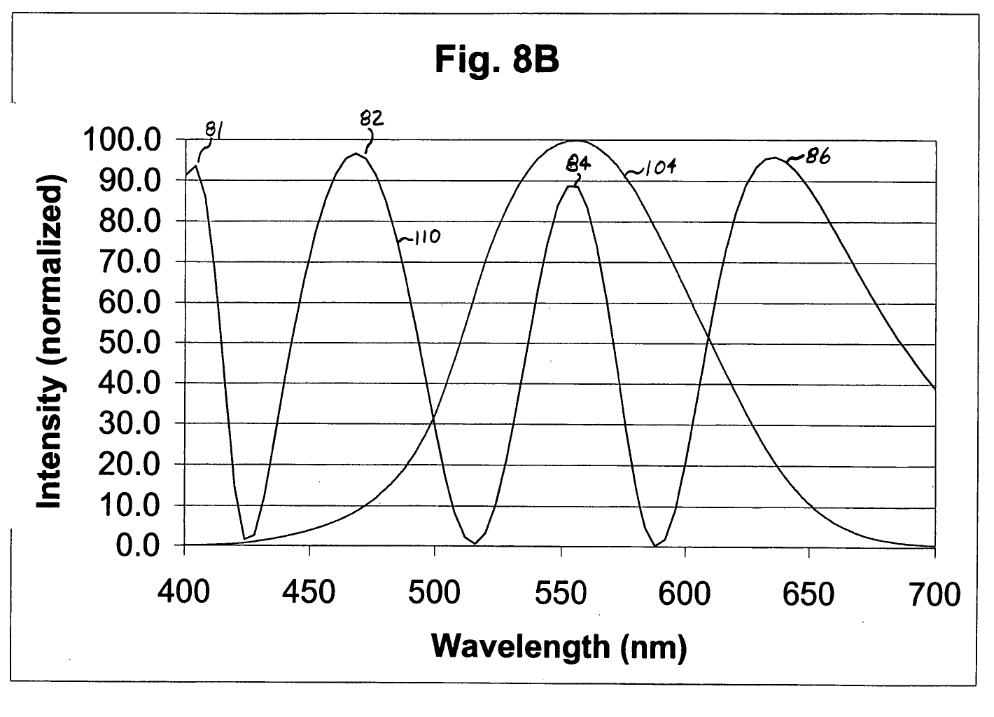

Referring to FIG. 8A, there is shown a curve 110 representing the spectral response of a screen using the etalon-type multilayer interference filter of FIGS. 6 and 7 and a curve 108 representing the emission spectrum of a projector using the mercury vapor bulb represented by curve 108 and employing filtering and wavelength band enhancing techniques described above. FIG. 8B shows the curve 110 representing the spectral response of the screen of FIGS. 6 and 7 and the photoptic curve 104.

The screen spectral response curve 110 has peaks 81, 82, 84, and 86 at about 405 nm, 470 nm, 550 nm, and 635 nm, respectively. The 405 nm peak 81 is at a wavelength in the ultraviolet range and at a wavelength to which the human eye has very low sensitivity. The 470 nm peak 82 is (referring to FIG. 5) at a wavelength at which the relative level of energy has been enhanced. The 550 nm peak 84 is at a wavelength that is both a wavelength at which the human eye has high sensitivity and also a wavelength at which the curve 108 representing the energy emitted by the projector has a peak. The 635 nm peak 86 is at a wavelength at which the relative level of energy has been enhanced and at which the absolute level of energy has also been enhanced. The spectral characteristics of the screen and the spectral characteristics of the bulb (as modified by the projector) have been matched to enhance the amount of energy that is emitted by the projector and selectively reflected by the screen. A projection system including a projector as described in FIG. 5 and a screen as described in FIGS. 6-8B has high efficiency relative to other combinations of light source, projector, and screen.

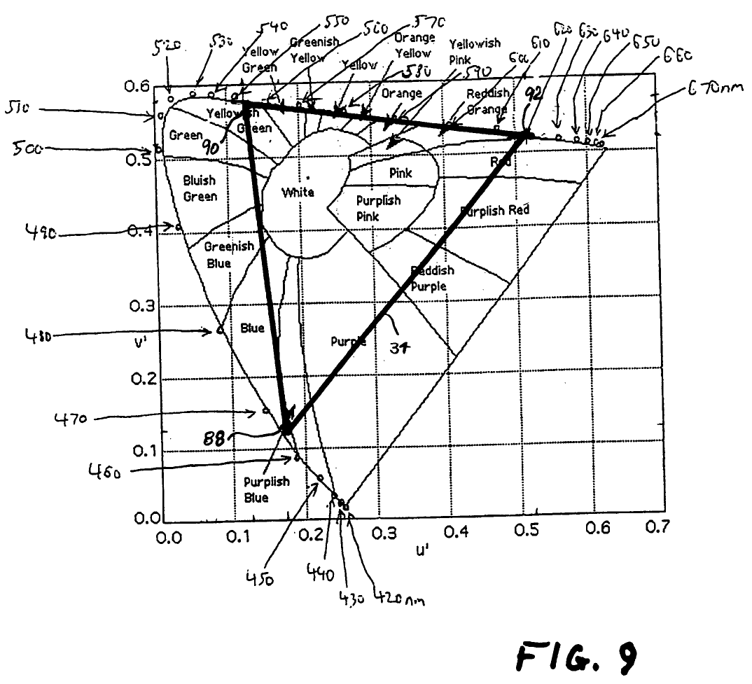

FIG. 9 shows the color chart 102 with the triangle 34 defined by the wavelength peaks of the screen of FIGS. 6 and 7 and with the enhanced mercury vapor spectrum of curve 108 from FIG. 5. The vertices 88, 90, 92 of the triangle 34 differ slightly from the wavelength peaks (470 nm, 550 nm, and 635 nm) of the screen of FIGS. 6 and 7 because of the effect of the projected light spectrum. The projected light from this enhanced mercury vapor source is fairly broadband compared to monochromatic laser light. The blue vertex 88 and the red vertex 92 are not as close to the corners 32 and 30 of the color chart as are the wavelengths of the screens depicted in FIG. 2. However, the difference is to some extent offset by the fact that the human eye is more sensitive to the wavelengths of the blue vertex 88 and the red vertex 92. In addition, FIG. 9 shows that triangle 34 includes large portions of the blue, purplish blue, purple, reddish purple, purplish red, and red sections of the color chart, indicating that the color gamut defined by triangle 34 can accurately reproduce a wide range of colors, including substantially all of the colors of standards such as Recommendation ITU-R BT.709-4 color standard which is the color space used by creators and editors of content for high-definition television.

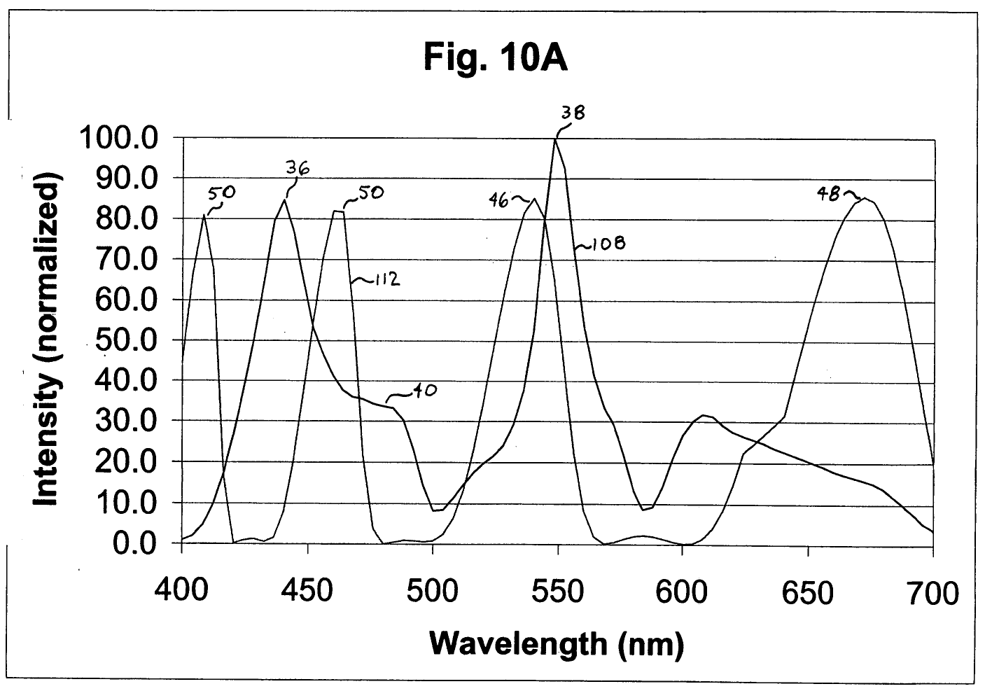

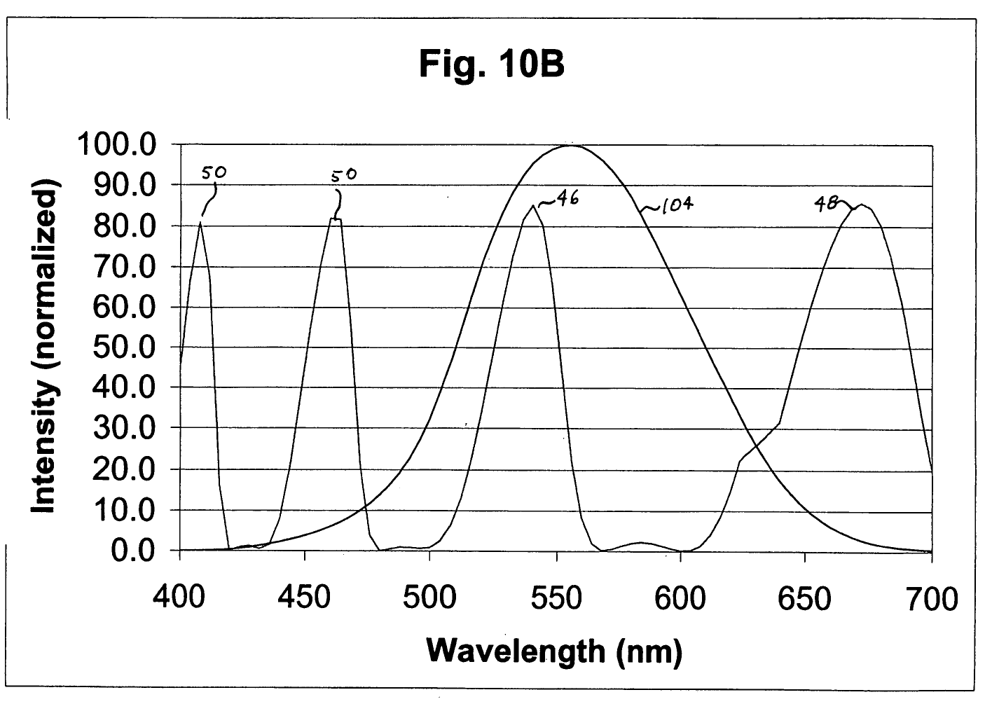

FIGS. 10A and 10B show the non-normalized spectral response 112 (expressed in reflectivity) of a projection screen with one dielectric layer 551 nm thick between each pair of reflective layers, similar to '558, calculated according to standard techniques. In FIG. 10A, the spectral response 112 is shown superimposed on the output curve 108 of a projector as described above in the discussion of FIG. 5. The projector green emission peak 38 at about 550 nm does not coincide with the green peak 46 of the screen spectral response, so the screen described in '558 does not take full advantage of the projector emission peak. The red screen response peak 48 does not coincide with the maximum 52 of emitted light in the red range by the projector. Referring to FIG. 10B, blue response peaks 50 and red response peak 48 are at wavelengths of low eye sensitivity.

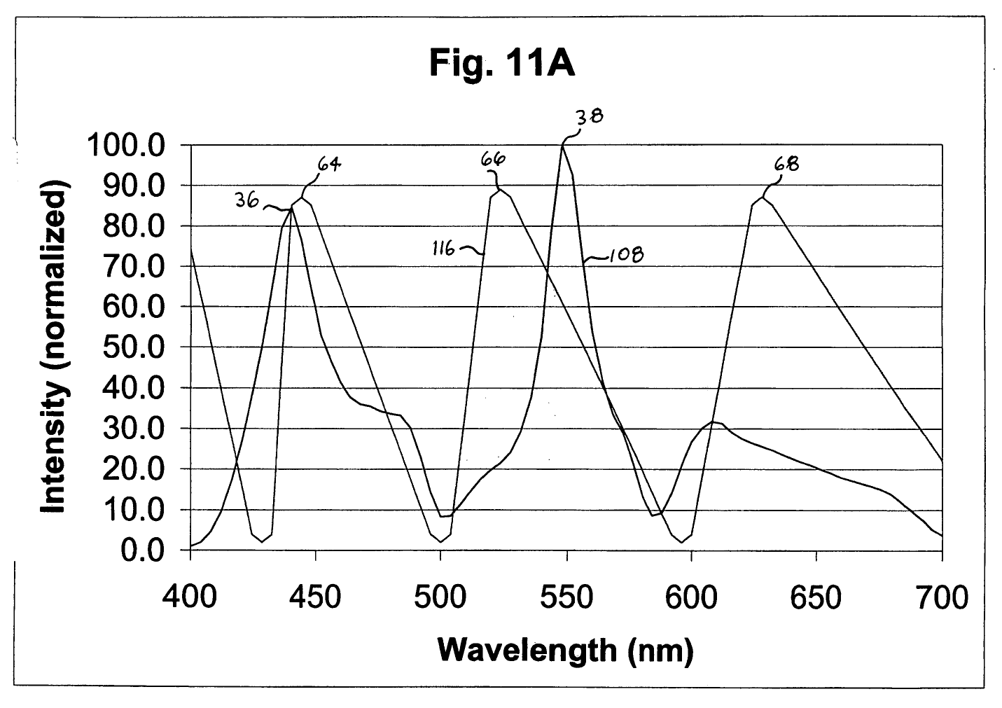

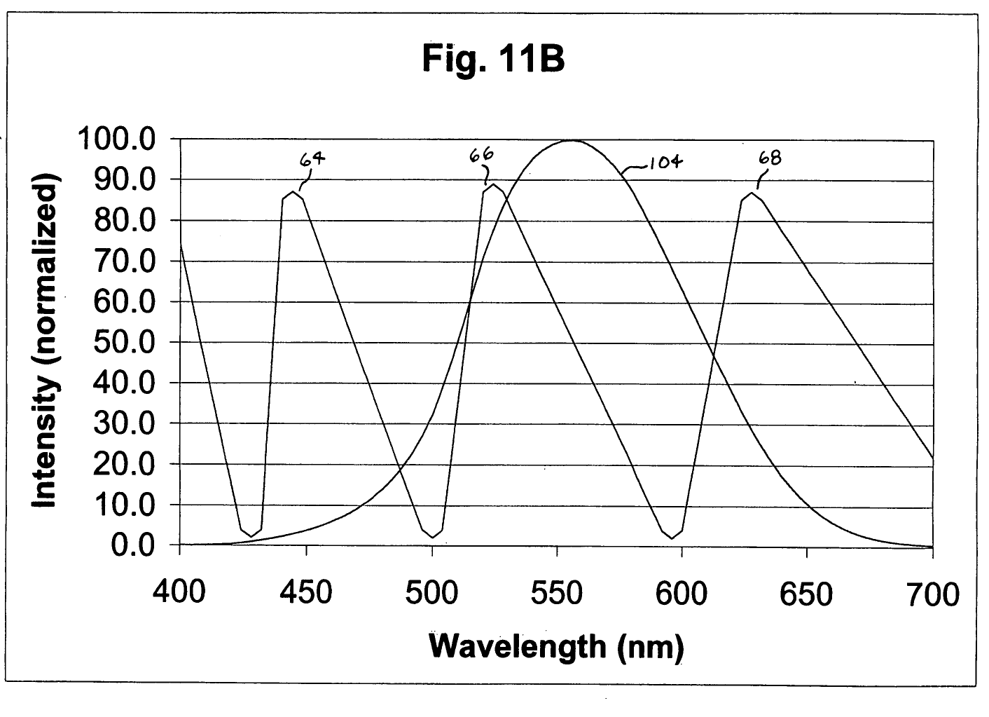

FIGS. 11A and 11B show the spectral response 116 (expressed in reflectivity) of the projection screen described by patent application '326, based on FIG. 1 of '326. In FIG. 11A, the spectral response 116 is shown superimposed on the output curve 108 of a projector as described above in the discussion of FIG. 5. The projector green emission peak 38 at about 550 nm does not coincide with the green peak 66 of the screen spectral response, so the screen described in '326 does not take full advantage of the projector emission peak. Referring to FIG. 10B, blue response peak 64 is at a wavelength of low eye sensitivity.

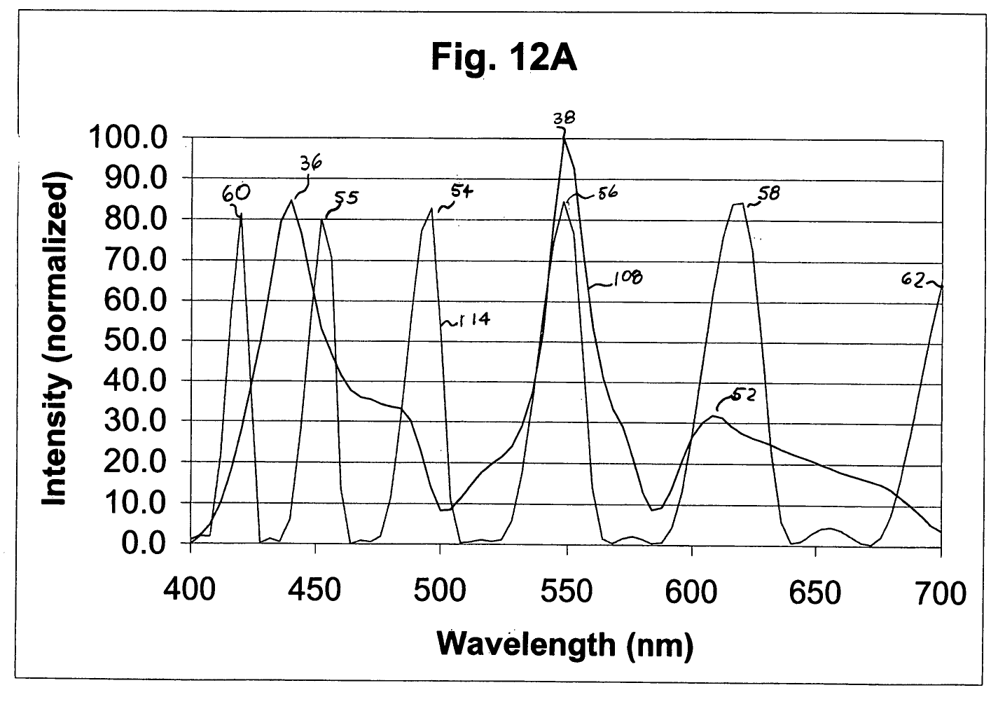

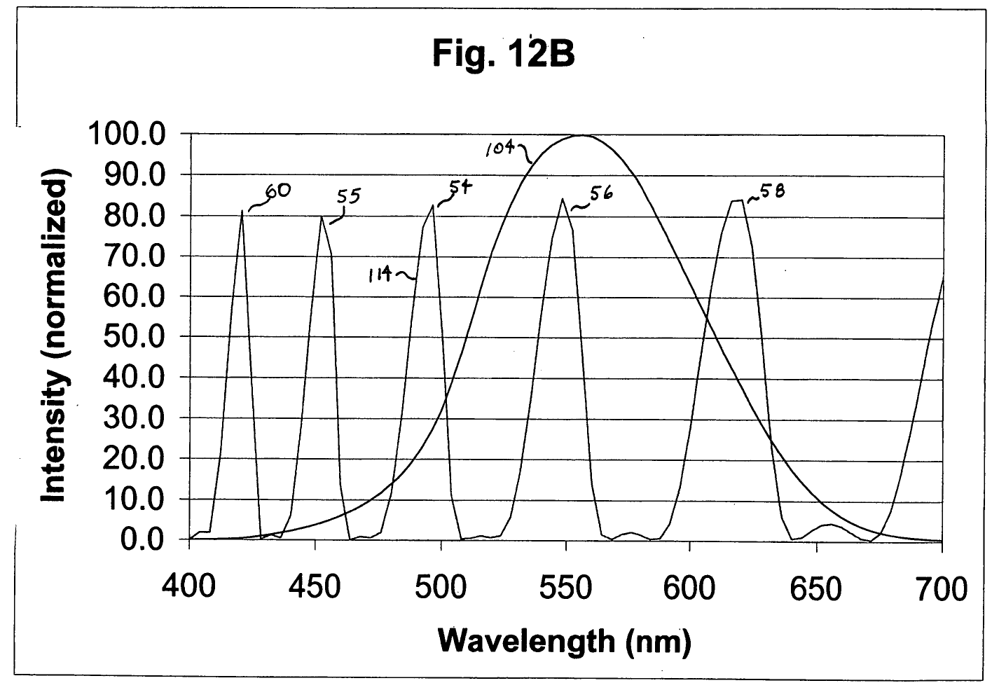

Some modifications can be made to the screen design described by patent application '558 to match the frequency response of the screen with the emission characteristics of the mercury vapor bulb projector. One modification is to decrease the intervals between the peaks in the spectral response of the screen. Decreased intervals in the spectral response of the screen allows the green selectively reflected wavelength band to be lined up with the emission peak of the mercury vapor bulb, while allowing the red and blue selectively reflected wavelength bands to be positioned at wavelength bands that are not at low points of the photopic curve. One way of modifying the intervals between spectral response peaks is to change the thickness of the dielectric layers. For example, FIGS. 12A and 12B show a curve 114 representing the spectral response, calculated according to standard techniques, of a screen according to patent application '558 in which the thickness of the Nb₂O₅ layers has been increased from 551 nm to 910 nm. In FIG. 12A, curve 114 is plotted against projector emission curve 108, and in FIG. 12B, curve 114 is plotted against photopic curve 104. In FIG. 12A, green spectral response peak 56 coincides with projector emission peak 38 and red spectral response peak 58 substantially coincides with projector red peak 52. As shown in FIG. 12B, red spectral response peak 58 and blue spectral response peak 54 are in wavelength bands in which the photopic curve 104 indicates greater sensitivity of the human eye than the portions of the photopic curve coinciding with the red spectral response peak 48 (FIG. 10B) and the blue spectral response peak 50 (FIG. 10B) of the screen according to patent application '558. Secondary blue spectral response peak 55 contributes additional selective reflection of blue light.

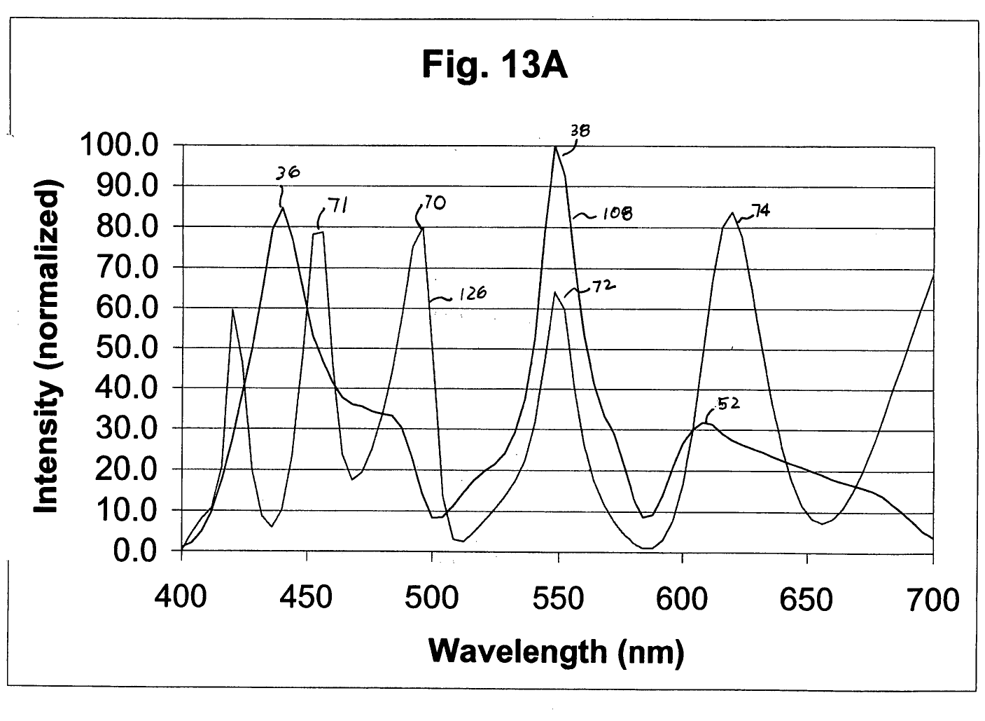

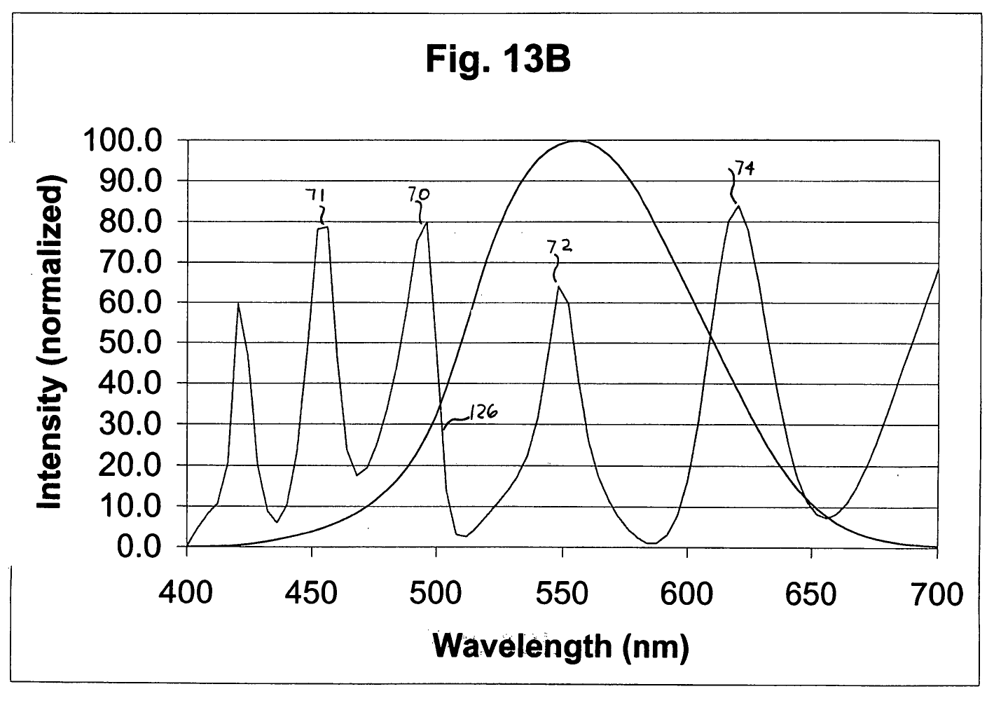

FIGS. 13A and 13B show a curve 126 representing the spectral response, calculated according to standard techniques, of a screen with a single layer of dielectric between each pair of layers of metallic material, similar to '558 in which the thickness of the Nb₂O₅ layers has been decreased from 551 nm to 280 nm. In FIG. 13A, curve 126 is plotted against projector emission curve 108, and in FIG. 13B, curve 126 is plotted against photopic curve 104. In FIG. 13A, green spectral response peak 72 coincides with projector emission peak 38 and the reflectivity is reduced relative to other emission peaks. This can be advantageous, because mercury vapor bulbs have more green light content than is necessary, and the amount of green light typically needs to be reduced, as discussed above and in U.S. patent application Ser. No. 10/028,063. Reduced reflectivity of green light in the screen (rather than reduction in the projector) is advantageous because the screen will then reflect less ambient light in the green wavelength band. The overall effect is to increase contrast by utilizing green light that would otherwise be discarded in the projector. Red spectral response peak 74 substantially coincides with projector red peak 52. As shown in FIG. 13B, red spectral peak 74 and blue spectral response peak 70 are in wavelength bands in which the photopic curve 104 indicates greater sensitivity of the human eye than the portions of the photopic curve coinciding with the red spectral response peak 48 (FIG. 10B) and the blue spectral response peak 50 (FIG. 10B) of the screen according to patent application '558. Secondary blue spectral response peak 71 contributes additional selective reflection of blue light.

One formula for determining the parameters of a screen constructed according to application '558 that yields reflectivity peaks suitable for use with a mercury vapor bulb is given by

$$λ = \frac{2 nD + nM + 2 nC}{m}$$

where values of λ are the center of wavelength bands of peak reflectivity; n is the index of refraction of the dielectric material; D is thickness of the dielectric layer in nanometers; M is the thickness of the second metal layer (such as layer 12 M2 of '558); C is a constant depending on the metal of the first reflective layer (for example C is 14 for Al 17 Nb, and 22 for Ag); and m is an integer that represents the number of the peak. This formula is only valid for values of the variables that make clearly defined peaks and valleys in the optical spectrum of the coating reflectivity. Using Nb₂O₅ (n=2.35) as the dielectric material, D=910 nm, M=15 nm, aluminum (C=14) yields the following

| m | λ (nm) |
|---|---|
| 1 | 4378 |
| 2 | 2189 |
| 3 | 1459 |
| 4 | 1095 |
| 5 | 876 |
| 6 | 730 |
| 7 | 625 |
| 8 | 547 |
| 9 | 486 |
| 10 | 438 |

The values of λ for m=1 . . . 6 and 10 . . . are outside the spectral band visible to the human eye. The values of λ for m=7, 8, and 9 are 625 nm, 547 nm, and 486 nm, respectively. As can be seen by comparing these three wavelengths with the emission spectrum of a projector using a mercury vapor bulb light source, for example curve 112 of FIG. 10A, these three wavelengths are suitable for a selective reflecting screen to be used with a mercury vapor bulb. The formula can also be used with selective reflecting screens of the type described in application '558 having multiple alternating metal and dielectric layers. For multiple alternating dielectric layers, D is thickness in nanometers of each of the dielectric layers and M is the thickness of the each of the additional metal layers.

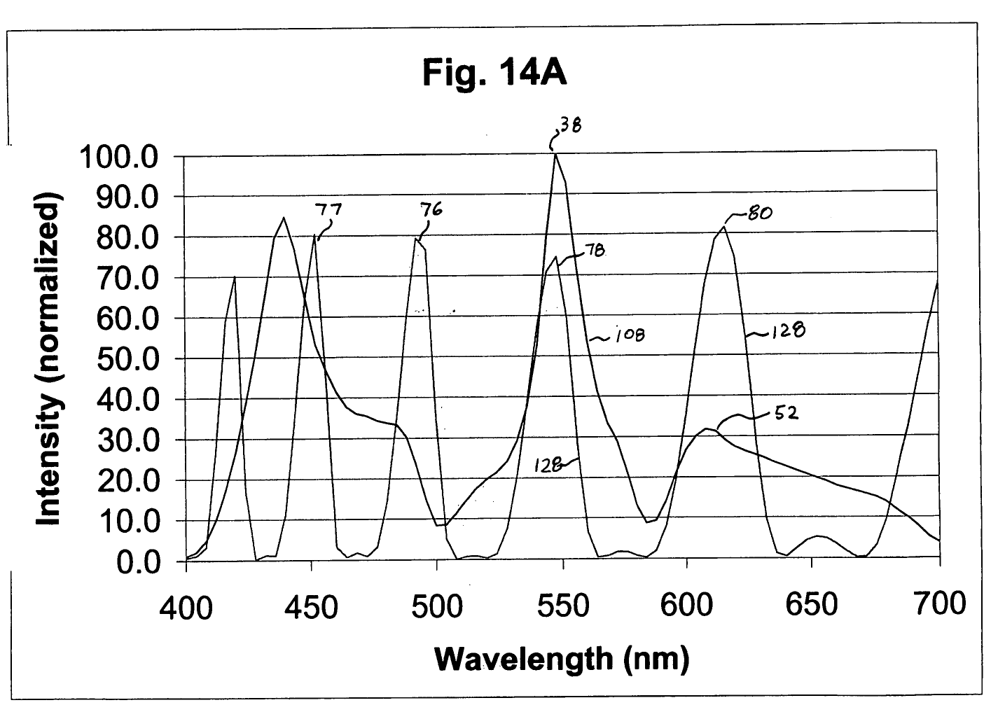

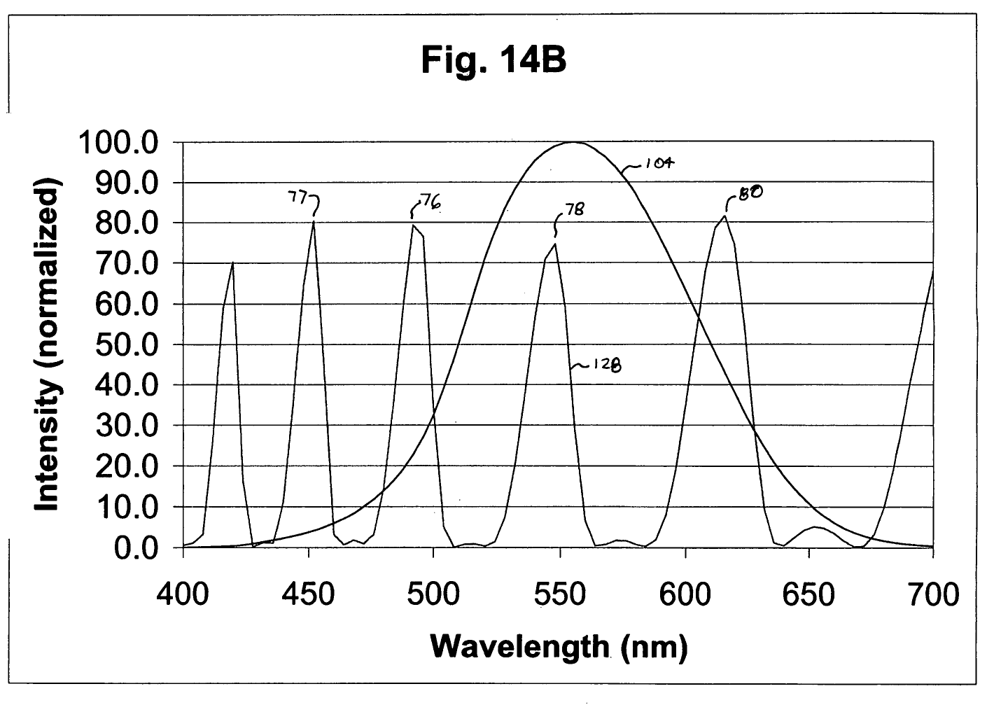

FIGS. 14A and 14B show a curve 128 representing the spectral response, calculated according to standard techniques, of a screen according to '558 with the layers of the following thicknesses and materials: 50 nm Al (bottom layer); 907 nm Nb2O5; 15 nm Nb; 623 nm Nb2O5; 0.6 nm Nb; and 284 nm Nb2O5. In FIG. 14A, curve 128 is plotted against projector emission curve 108, and in FIG. 14B, curve 128 is plotted against photopic curve 104. In FIG. 14A, green spectral response peak 78 coincides with projector emission peak 38 and the reflectivity is reduced relative to other emission peaks, but not reduced as much as the screen of FIGS. 13A and 13B. As with the screen of FIGS. 13A and 13B, this can be advantageous, because mercury vapor bulbs have more green light content than is necessary, and the amount of green light may need to be filtered, as disclosed above and in U.S. patent application Ser. No. 10/028,063. Reducing the reflectance of green light by adjusting the thickness of a dielectric layer can reduce or eliminate the need for filtering the green light. Red spectral response peak 80 substantially coincides with projector red peak 52. As shown in FIG. 14B, red spectral response peak 80 and blue spectral response peak 76 are in wavelength bands in which the photopic curve 104 indicates greater sensitivity of the human eye than the portions of the photopic curve coinciding with the red spectral response peak 48 (FIG. 10B) and the blue spectral response peak 50 (FIG. 10B) of the screen according to patent application '558. Secondary blue spectral response peak 77 contributes additional selective reflection of blue light.

Similar adjustments, for example changing the thicknesses of the layers, can be made to the screen described by patent application '326. However the degree to which adjustments can match the screen spectral response with the projector peaks and the photopic curve are more limited than with the screen of application '558 because patent application '326 describes a Fabry-Perot device with only one dielectric layer.

Numerous uses of and departures from the specific apparatus and techniques disclosed herein may be made without departing from the inventive concepts. Consequently, the invention is to be construed as embracing each and every novel feature and novel combination of features disclosed herein and limited only by the spirit and scope of the appended claims.

1. A projection system, comprising:
a projector for projecting light in wavelength bands, comprising a non-laser light source;
a screen comprising at least two metallic layers separated by a layer of dielectric material constructed and arranged to reflect light in the wavelength bands and to not reflect light not in the wavelength bands.

2. A projection system in accordance with claim 1, the light source comprising a bulb.

3. A projection system in accordance with claim 2, the bulb having a non-flat emission spectrum.

4. A projection system in accordance with claim 3, wherein the bulb is a short-arc mercury vapor bulb

5. A projection system in accordance with claim 3, wherein the non-flat emission spectrum has an energy peak at a predetermined wavelength, and wherein the projector comprises a filter to filter light in a wavelength band including the predetermined wavelength to decrease the relative amount of energy in the wavelength band relative to the amount of energy in other wavelength bands.

6. A projection system in accordance with claim 5, wherein the non-flat emission spectrum has a second energy peak at a second predetermined wavelength, and wherein the projector comprises a second filter to filter light in a second wavelength band including the second predetermined wavelength to decrease the relative amount of energy in the second wavelength band relative to the amount of energy in other wavelength bands.

7. A projection system in accordance with claim 5, wherein the projector further comprises a light source for supplementing in a band of wavelengths the light energy emitted by the bulb.

8. A projection system in accordance with claim 1, wherein the light source has a broadband emission spectrum having an emission peak at an emission peak wavelength and wherein one of the wavelength bands includes the emission peak wavelength.

9. A projection system in accordance with claim 8, wherein the light source comprises a mercury vapor bulb and wherein the emission peak occurs at approximately 550 nm.

10. A projection system in accordance with claim 9, wherein a second of the bands includes 470 nm.

11. A projection system in accordance with 1, wherein the projector projects light in wavelength bands that are greater than 50 nm wide at full-width half-maximum.

12. A projection system in accordance with claim 1, wherein the metallic layers comprise a metallic film.

13. A projection system, comprising:
a screen, comprising at least two metallic layers separated by a layer of dielectric material constructed and arranged to reflect light in the wavelength bands and to not reflect light not in the wavelength bands; and
a projector, constructed and arranged to emit light in the pre-determined wavelength bands, comprising
a non-laser light source having a non-flat emission spectrum having an emission peak in a first of the wavelength bands; and
an emission spectrum modifier to modify the non-flat emission spectrum by increasing the energy in a second of the pre-determined wavelength bands relative to the energy in the first wavelength band.

14. A projection system in accordance with claim 13, wherein the emission spectrum modifier comprises a filter to reduce emission in the spectral portion including the emission peak.

15. A projection system in accordance with claim 14, wherein the emission spectrum modifier further comprises a narrowband supplementary light source to increase the energy in a spectral portion not having an emission peak.

16. A projection system in accordance with claim 13, wherein the emission spectrum modifier further comprises a supplementary narrowband light source to increase the energy in a spectral portion not having an emission peak.

17. A projection system in accordance with claim 16, wherein the spectral portion corresponds to one of the pre-determined wavelength bands.

18. A method for constructing a projection system, comprising:
a projector having a broadband spectral emission pattern having an emission peak at a predetermined wavelength; and
a screen constructed and arranged to preferentially reflect light in a plurality of wavelength bands, one of the plurality of predetermined wavelength bands including the predetermined wavelength, the screen comprising at least two metallic layers separated by a layer of dielectric material.

19. A projection system, comprising:
a projector for projecting light in wavelength bands, the projector comprising a light source with a non-flat broadband emission spectrum having an emission peak at an emission peak wavelength;
a screen comprising a first metallic layer and a second metallic separated by a first layer of dielectric material, constructed and arranged to reflect light in the wavelength bands and to not reflect light not in the wavelength bands, wherein a first of the wavelength bands includes the emission peak wavelength.

20. A projection system in accordance with claim 19, wherein the light source is a mercury vapor bulb and wherein the emission peak wavelength is approximately 550 nm.

21. A projection system in accordance with claim 19, wherein a second of the wavelength bands includes 470 nm.

22. A projection system in accordance with claim 19, wherein the projector is constructed and arranged to project light in wavelength bands that have a width of greater than 50 nm at full-width half-maximum.

23. A projection system in accordance with claim 19 the screen further comprising at least one additional metallic layer separated from the second metallic layer by a second dielectric layer.

24. A projection system in accordance with claim 23, wherein the thickness of the additional reflective layer is the same as the second reflective layer.

25. A projection system in accordance with claim 24, wherein the thickness of the second dielectric layer is the same as the thickness of the first dielectric layer.

26. A projection system in accordance with claim 19, the screen further comprising a plurality of alternating layers of dielectric material and metallic layers disposed on the second metallic layer.

27. A projection system in accordance with claim 26, wherein the alternating layers of dielectric material have the same thickness as the first layer of dielectric material and wherein the alternating metallic layers have the same thickness as the second metallic layer.

28. A projection system in accordance with claim 26, wherein the alternating layers of dielectric material have different thicknesses.

29. A projection screen constructed and arranged so that the reflectivity of light in a plurality of predetermined wavelength bands is significantly greater than the reflectivity of light in other wavelength bands, comprising:
a first and second layer of reflective material, separated by a layer of a dielectric material, wherein the central wavelengths of the wavelength bands of greater reflectivity are given by
$$λ = \frac{2 nD + nM + 2 nC}{m}$$
where values of λ are the central wavelengths of the wavelength bands; n is the index of refraction of the dielectric material; D is the thickness of the layer of dielectric material in nanometers; M is the thickness of the second reflective layer in nanometers; C is a constant depending on the material of the first reflective layer; and m is an integer that represents the number of the peak.

30. A projection screen in accordance with claim 29, further comprising:
a third layer of reflective material, separated from the second layer of reflective material by a second layer of the dielectric material, wherein the central wavelengths of the wavelength bands of greater reflectivity are given by
$$λ = \frac{2 nD + nM + 2 nC}{m}$$
where values of λ are the central wavelengths of the wavelength bands; n is the index of refraction of the dielectric material of the first and second layers of dielectric material; D is the thickness of the first and second layers of dielectric material in nanometers; M is the thickness of the second and the third reflective layer in nanometers; C is a constant depending on the material of the first reflective layer; and m is an integer that represents the number of the peak.

31. A projection screen in accordance with claim 29, further comprising:
an alternating plurality of layers of dielectric material and reflective material, wherein the central wavelengths of the wavelength bands of greater reflectivity are given by
$$λ = \frac{2 nD + nM + 2 nC}{m}$$
where values of λ are the central wavelengths of the wavelength bands; n is the index of refraction of the dielectric material of the alternating plurality of layers of dielectric material; D is the thickness of the alternating layers of dielectric material in nanometers; M is the thickness of the alternating reflective layers in nanometers; C is a constant depending on the material of the first reflective layer; and m is an integer that represents the number of the peak.

32. A projection screen in accordance with claim 29 wherein the values of m are 7, 8, and 9.
